(19) United States
(12) Patent Application Publication
(10) Pub. No.: US 2009/0029227 A1
(43) Pub. Date: Jan. 29, 2009

(54) APPARATUS, SYSTEM, AND METHOD FOR SECURING A CARTRIDGE

(76) Inventors: John Patton, West Jordan, UT (US); Chris A. Brydon, Salt Lake City, UT (US); Ken Pearson, Shingle Springs, CA (US)

Correspondence Address: Kunzler & McKenzie, 8 EAST BROADWAY, SUITE 600, SALT LAKE CITY, UT, 84111, US

(21) Appl. No.: 12/179,554

(22) Filed: Jul. 24, 2008

Related U.S. Application Data
(60) Provisional application No. 60/951,903, filed on Jul. 25, 2007.
(60) Provisional application No. 60/951,907, filed on Jul. 25, 2007.
(60) Provisional application No. 60/951,925, filed on Jul. 25, 2007.
(60) Provisional application No. 61/059,743, filed on Jun. 6, 2008.

(51) Int. Cl. H01M 2/10

(52) U.S. Cl. 429/34

(57) ABSTRACT

An apparatus, system, and method are disclosed for securing a cartridge. A cartridge may contain a fluid processing component such as a fluid filtration component, a fluid generation component, a fluid consumption component, or a fluid containment. The cartridge has a cartridge interface. An interface fluid outlet port is disposed on the cartridge interface. The interface fluid outlet port is in fluid communication with an interior of the cartridge. The interface fluid outlet port is configured to mate with a receiver fluid inlet port of a cartridge receiver. A biasing member applies a biasing force that presses the interface fluid outlet port against the receiver fluid inlet port. The biasing force removably secures the cartridge to the cartridge receiver.

### CROSS-REFERENCES TO RELATED APPLICATIONS

This application claims the benefit of U.S. Provisional Patent Application No. 60/951,903 entitled “APPARATUS, SYSTEM, AND METHOD FOR GENERATING HYDROGEN FROM A CHEMICAL HYDRIDE” and filed on Jul. 25, 2007 for John Patton, et. al which is incorporated herein by reference. This application incorporates by reference U.S. patent application Ser. Nos. 10/459,991 filed Jun. 11, 2003, 11/270,947 filed Nov. 12, 2005, 11/740,349 filed Apr. 26, 2007, 11/828,265 filed Jul. 25, 2007, 11/829,019 filed Jul. 26, 2007, and 11/829,035 filed Jul. 26, 2007; and U.S. Provisional Patent Application Ser. Nos. 60/951,907 filed Jul. 25, 2007, 60/951,925 filed Jul. 25, 2007, and 61/059,743 filed Jun. 6, 2008, each of which is incorporated by reference herein in its entirety.

### BACKGROUND OF THE INVENTION

1. Field of the Invention

This invention relates to cartridges and more particularly relates to fuel cartridges.

2. Description of the Related Art

As the cost of fossil fuels increases, pollution increases, and the worldwide supply of fossil fuels decreases, alternative energy sources are becoming increasingly important. Hydrogen is a plentiful alternative energy source, but it generally exists in a combination with other elements, and not in a pure form. The additional elements add mass and may prevent the hydrogen from being used as an energy source. Pure hydrogen, however, is a desirable energy source. Pure hydrogen comprises free hydrogen atoms, or molecules comprising only hydrogen atoms. Producing pure hydrogen using conventional methods is generally cost prohibitive.

One way that pure hydrogen can be generated is by a chemical reaction which produces hydrogen molecules. The chemical reaction that occurs between water (H₂O) and chemical hydrides produces pure hydrogen. Chemical hydrides are molecules comprising hydrogen and one or more alkali or alkali-earth metals. Chemical hydrides produce large quantities of pure hydrogen when reacted with water.

Recently, the interest in hydrogen and other alternative fuels has increased, as more efficient applications have been developed for their use. For example, the development of lightweight, compact Proton Exchange Membrane (PEM) fuel cells has increased the interest in hydrogen and hydrogen generation. Difficulties with transportation and storage commonly arise with alternative fuels such as hydrogen and hydrogen generating chemicals. Some alternative fuels and fuel sources can be combustible or toxic and may require extra safety concerns. The generation of fuels such as hydrogen can also create high temperatures and pressures. The storage of gaseous fuels can also require high pressures.

New uses for alternative fuels, especially portable applications, require safe and simple fuel storage and transportation. Systems for storing and generating fuels often have many components to manage temperatures, pressures, and other factors. These systems can be complicated and counterintuitive to operate because of the many components used for safety and efficiency. Additionally, the pressures that are often involved in fuel storage and generation can force fuel storage interfaces and components apart, decreasing their life, damaging them, and creating unsafe conditions for users.

Accordingly, what is needed is an improved apparatus, system, and method for securing a cartridge that overcome the problems and disadvantages of the prior art. The apparatus, system, and method should manage high temperatures and pressures while remaining simple, safe, and intuitive without forcing interfaces or components apart. In particular, the apparatus, system, and method should safely and efficiently contain hydrogen based fuels and hydrogen supply or generation devices.

### SUMMARY OF THE INVENTION

From the foregoing discussion, it should be apparent that a need exists for an apparatus, system, and method that secures a cartridge used in the providing, processing, and generation of hydrogen and other fuels in a safe and efficient manner. Beneficially, such an apparatus, system, and method would be durable, intuitive, and use fewer components than other alternatives.

The present invention has been developed in response to the present state of the art, and in particular, in response to the problems and needs in the art that have not yet been fully solved by currently available cartridge securing systems. Accordingly, the present invention has been developed to provide an apparatus, system, and method for securing a cartridge that overcome many or all of the above-discussed shortcomings in the art. Certain cartridges that are secured may be used to supply or generate a fuel source such as hydrogen. Other types of cartridges used in energy supply and management systems are also considered within the scope of the present invention.

The apparatus to secure a cartridge is provided with a plurality of elements. These elements, in the described embodiments, include a cartridge, a cartridge interface, an interface fluid outlet port, an orientation angle, a biasing member, an interface fluid inlet port, and one or more alignment features.

The cartridge, in one embodiment, comprises the cartridge interface. In one embodiment, the cartridge is configured to contain a fluid processing component selected from the group consisting of a fluid filtration component, a fluid generation component, a fluid consumption component, and a fluid containment component. In a further embodiment, the cartridge is configured to contain a hydrogen generating reaction. In one embodiment, the hydrogen generating reaction is a chemical reaction between a liquid and a solid hydride reactant. In another embodiment, a liquid permeable material is disposed within the cartridge. In one embodiment, the liquid permeable material has one or more cavities. Each cavity, in another embodiment, is configured to contain the solid hydride reactant. In a further embodiment, the solid hydride reactant is a solid anhydrous chemical hydride. In another embodiment, the cartridge is configured to contain a hydrogen filtration system.

The interface fluid outlet port, in another embodiment, is disposed on the cartridge interface. In a further embodiment, the interface fluid outlet port is in fluid communication with an interior of the cartridge. In one embodiment, the interface fluid outlet port is configured to mate with a receiver fluid inlet port of a cartridge receiver.

In a further embodiment, the orientation angle is measured between the interface fluid outlet port and a plane orthogonal to an insertion path of the cartridge. In one embodiment, the interface fluid outlet port and the insertion path of the cartridge are nonparallel. The orientation angle, in a further embodiment, is an angle between zero degrees and forty five degrees

The biasing member, in one embodiment, is configured to apply a biasing force that presses the interface fluid outlet port against the receiver fluid inlet port. In another embodiment, the biasing member is further configured to apply a biasing force that presses the interface fluid inlet port against the receiver fluid outlet port of the cartridge receiver. In a further embodiment, the biasing member is configured to compress to generate the biasing force in response to an insertion of the cartridge into the cartridge receiver. The biasing member, in one embodiment, is at least partially elastomeric. In another embodiment, the biasing member has a seal that substantially circumscribes the interface fluid outlet port. The seal, in one embodiment, is configured to release a fluid in response to an internal pressure above a threshold pressure.

The interface fluid inlet port, in another embodiment, is in fluid communication with the interior of the cartridge. In one embodiment, the interface fluid inlet port is configured to mate with a receiver fluid outlet port of the cartridge receiver. In a further embodiment, the interface fluid inlet port has an orientation angle, and the orientation angle is measured from a plane orthogonal to the insertion path of the cartridge. In another embodiment, the fluid inlet port and the insertion path of the cartridge are nonparallel. The interface fluid inlet port, in one embodiment, is diametrically opposed to the interface fluid outlet port.

In a further embodiment, the one or more alignment features are configured to ensure that the insertion path of the cartridge and an alignment of the cartridge are proper. In another embodiment, the interface fluid outlet port is incorporated into the one or more alignment features. The one or more alignment features, in one embodiment, have one or more shoulders configured to interface with a support surface of the cartridge receiver. In another embodiment, the one or more alignment features are a shape of the cartridge. The one or more alignment features, in a further embodiment, are a shape of the cartridge interface. In another embodiment, the one or more alignment features cause the cartridge to rotate at least partially about the insertion path to achieve a proper alignment.

An apparatus of the present invention to generate hydrogen is also presented. The apparatus, in the described embodiments, includes several elements, such as a cartridge receiver, a receiver gas port, a biasing member, a cartridge cooling module, a receiver fluid port, and one or more alignment features.

The cartridge receiver, in one embodiment, is configured to receive a cartridge interface of a fuel cartridge. In a further embodiment, the receiver gas port is disposed on the cartridge receiver. In one embodiment, the receiver gas port is configured to mate with an interface gas outlet port of the cartridge interface.

In one embodiment, the biasing member is configured to apply a biasing force that presses the receiver gas port against the interface gas outlet port. In a further embodiment, the biasing member removably secures the fuel cartridge to the cartridge receiver. In one embodiment, the biasing member is further configured to remove contaminants from the interface gas outlet port in response to an insertion of the fuel cartridge into the cartridge receiver.

The cartridge cooling module, in one embodiment, is configured to conduct heat away from the fuel cartridge. The cartridge cooling module, in another embodiment, comprises a fluid moving module configured to cause a fluid to move through a fluid guide disposed adjacent to the fuel cartridge. The fluid guide, in one embodiment, is a helical rib formed in the cartridge receiver. The fluid, in one embodiment, comprises air. In one embodiment, the helical rib forms a helical path for airflow around the fuel cartridge when the fuel cartridge is positioned within the cartridge receiver. In a further embodiment, the fluid guide is further configured to create turbulence in the fluid from the fluid moving module. Those in the art recognize that the fluid may be air, water, gels, alcohols, antifreeze, or the like. In another embodiment, the fluid guide comprises a water jacket.

The receiver fluid port, in one embodiment, is disposed on the cartridge receiver. In a further embodiment, the receiver fluid port is configured to mate with an interface fluid inlet port of the cartridge interface. The receiver fluid port and the receiver gas port, in one embodiment, are disposed opposite each other and are configured to apply the biasing force to the interface gas outlet port and to the interface fluid inlet port.

In one embodiment, the one or more alignment features are disposed on the cartridge receiver. The one or more alignment features, in another embodiment, are configured to ensure that an insertion path of the fuel cartridge into the cartridge receiver and an alignment of the fuel cartridge relative to the cartridge receiver are proper. The receiver gas port, in another embodiment, is incorporated into the one or more alignment features. In a further embodiment, the one or more alignment features are a shape of the cartridge receiver.

A system of the present invention is also presented to generate hydrogen. The system may be embodied by a fuel cartridge, an interface gas outlet port, a cartridge receiver, a receiver gas port, and a biasing member. In particular, the system, in one embodiment, includes an interface fluid inlet port, a cooling module, a pressure relief valve, and a full insertion module.

The pressure relief valve, in one embodiment, is configured to release hydrogen gas in response to an internal gas pressure above a threshold gas pressure. In one embodiment, the full insertion module is configured to prevent an operation of the system in response to an improper insertion of the fuel cartridge. In another embodiment, the full insertion module comprises a cover. The fuel cartridge, in one embodiment, prevents the cover from fully closing when the fuel cartridge is improperly inserted in the cartridge receiver.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for generating hydrogen in accordance with the present invention;

FIG. 2 is a schematic block diagram illustrating one embodiment of a cartridge in accordance with the present invention;

FIG. 3A is a schematic block diagram illustrating a further embodiment of a cartridge in accordance with the present invention;

FIG. 3B is a schematic block diagram illustrating one embodiment of a liquid permeable material in accordance with the present invention;

FIG. 4A is a side view of one embodiment of a hydrogen generation system interface in accordance with the present invention;

FIG. 4B is a side view of one embodiment of a hydrogen generation system interface in accordance with the present invention;

FIG. 5A is a side view of one embodiment of a cartridge interface in accordance with the present invention;

FIG. 5B is a side view of one embodiment of a cartridge interface 512 in accordance with the present invention;

FIG. 6A is a top view of a cartridge receiver in accordance with the present invention;

FIG. 6B is a cross-section view of a cartridge interface in accordance with one embodiment of the present invention; and

FIG. 7 is cross-section side view of one embodiment of a cooling module in a hydrogen generation system in accordance with the present invention.

### DETAILED DESCRIPTION OF THE INVENTION

Many of the functional units described in this specification have been labeled as modules, in order to more particularly emphasize their implementation independence. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

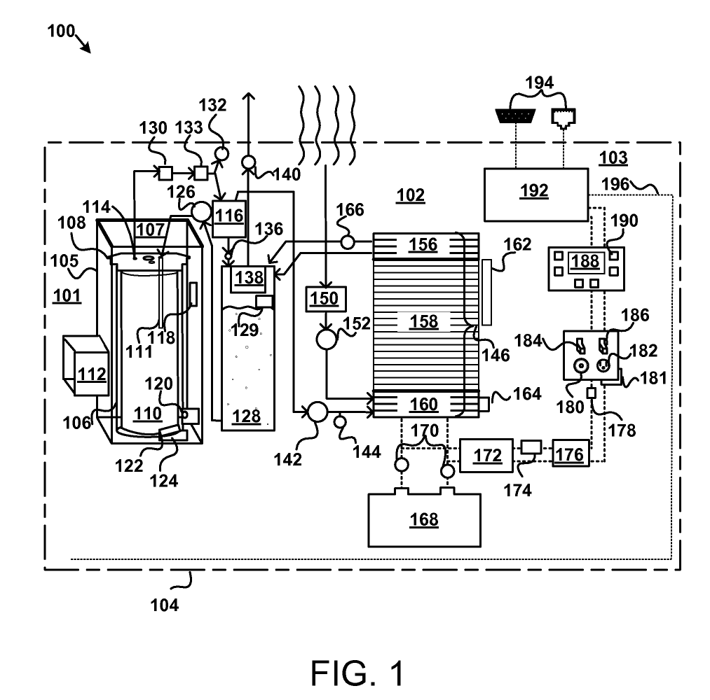

FIG. 1 depicts one embodiment of a system 100 for generating electricity from hydrogen in accordance with the present invention. The system 100 includes a hydrogen generation system 101, a hybrid hydrogen fuel cell system 102, an electrical and control system 103, and an outer housing 104.

In one embodiment, the hydrogen generation system 101 includes one or more cartridge receivers 105, one or more cartridges 106, a receiver lid 107, one or more alignment structures 108, a liquid permeable material 110, one or more liquid injection lines and tubes 111, one or more cooling modules 112, one or more hydrogen ports 114, a hydrogen cleaning system 116, a temperature sensor 118, a cartridge sensor 120, a radio frequency identification (RFID) tag 122, an RFID sensor 124, a liquid pump 126, a liquid reservoir 128, a liquid level sensor 129, a check valve 130, a hydrogen pressure sensor 132, one or more mechanical valves 133, a transfer valve 136, a water condenser 138, and a pressure control valve 140. In general, the hydrogen generation system 101 generates hydrogen using a liquid such as water, a chemical hydride, and an activating agent.

In one embodiment, the cartridge receiver 105 comprises a durable material that can withstand high temperatures associated with hydrogen generation. In a further embodiment, the cartridge receiver 105 also comprises a lightweight material, to keep the overall weight of the system 100 to a minimum for added portability. In one embodiment, the cartridge receiver 105 is a lightweight metal or metal alloy such as aluminum or the like. In a further embodiment, the cartridge receiver 105 comprises a fiberglass material, a plastic polymer material, a ceramic material, or another durable material. In one embodiment, the cartridge receiver 105 also comprises structures configured to receive, align, and lock the cartridge 106.

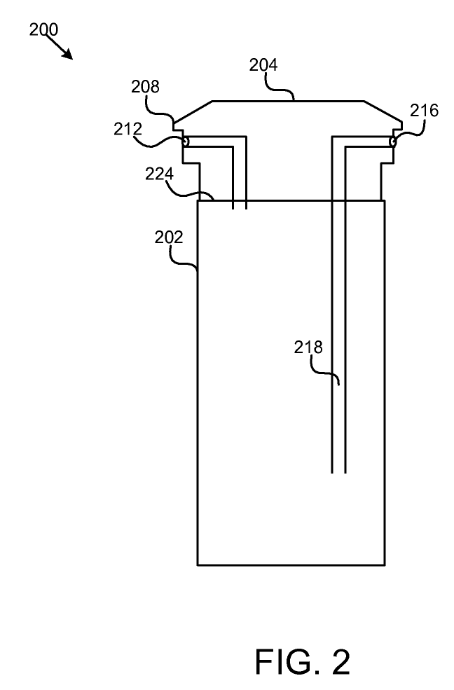

In one embodiment, the cartridge 106 locks into the cartridge receiver 105. The cartridge 106 is discussed in greater detail with reference to FIG. 2. In general, the cartridge 106 may be a fuel cartridge that is configured to house a chemical hydride and an activating agent, to receive a liquid such as water, to house a chemical reaction between the chemical hydride and the liquid which produces hydrogen gas, and to release the hydrogen. In another embodiment, the cartridge 106 may be configured to house another type of hydrogen producing reaction, to house or store a fluid, such as a fuel, to house one or more components or systems, such as a hydrogen filtration system, and the like. In one embodiment, the cartridge 106 is contains a fluid under pressure, the fluid may be a gas or a liquid. In one embodiment, the cartridge 106 is cylindrical in shape. The cylindrical shape provides structural strength to withstand the internal pressures as hydrogen is produced. The cartridge 106 may comprise a material configured to withstand the heat and pressure of the chemical reaction. The material may also comprise a lightweight material selected to minimize the weight of the cartridge 106, such as a lightweight metal or metal alloy like aluminum, a plastic polymer, or other durable material. In another embodiment, the cartridge 106 comprises a stamped aluminum cylindrical cartridge.

The receiver lid 107, in one embodiment, closes to secure the cartridge 106 in the cartridge receiver 105. In another embodiment, the receiver lid 107 may act as a backup securing system for the hydrogen cartridge 106. For example, the cartridge 106 may be secured to the cartridge receiver 105 by a securing mechanism (not shown), and the receiver lid 107 may close on the installed cartridge 106 to provide added security in the event of a failure of the securing mechanism (not shown).

In one embodiment, the hydrogen generation system 101 includes alignment structures 108, a shoulder, guide blocks, guide pins, or the like which may mate with corresponding alignment structures 108 on the cartridge 106. In another embodiment, the cartridge receiver 105 may include alignment structures 108, guide blocks, guide pins, or the like which may mate with corresponding alignment structures 108 on the cartridge 106.

In one embodiment, the top of the cartridge 106 has one or more alignment structures 108. In one embodiment, the one or more alignment structures 108 are configured to engage one or more corresponding alignment structures 108 of the cartridge receiver 105. The alignment structures 108 of the cartridge receiver 105 may be one or more of a shoulder support surface, guide blocks, pins, bolts, screws, keys, or the like. In a further embodiment, the alignment structures 108 comprise a shape of the cartridge 106 and/or of the cartridge receiver 105, the shape ensuring a proper insertion path and alignment of the cartridge 106 with respect to the cartridge receiver 105. Advantageously, the alignment structures 108 provide for quick and safe installation of a replacement cartridge 106. In one embodiment, the cartridge 106 is oriented vertically with respect to the outer housing 104. In this manner, a user may quickly remove a used cartridge 106 and insert a replacement cartridge 106. In a further embodiment, the cartridge 106 is oriented horizontally with respect to the outer housing 104. The alignment structures 108 ensure that inlet ports of the cartridge 106 lineup and seal properly.

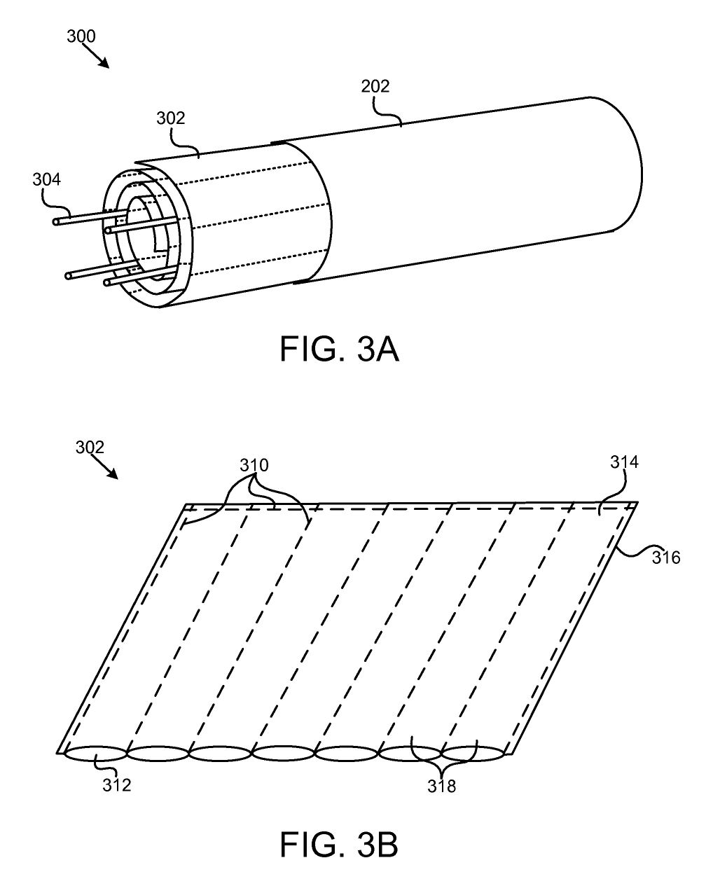

In one embodiment, the chemical hydride and the activating agent are stored in a liquid permeable material 110 within the cartridge 106. The liquid permeable material 110 is discussed in greater detail with reference to FIGS. 3A and 3B. In general, the liquid permeable material 110 comprises a material configured to distribute liquids evenly, without retaining a significant amount of the liquid. In a further embodiment, the liquid permeable material 110 is further configured with one or more sections or pouches, each section or pouch configured to hold and to evenly distribute a predetermined amount of the chemical hydride and the activating agent. The liquid permeable material 110 may be rolled as illustrated in FIG. 1, or may be in multiple rolls, folds, stacks, or other configurations. In one embodiment, the cartridge 106 includes a plurality of liquid permeable materials 110, each rolled as illustrated in FIG. 1, and distributed about a central longitudinal axis of the cartridge 106, with a central rolled liquid permeable material 110 centered about the central longitudinal axis of the cartridge 106.

In one embodiment, liquid enters the cartridge 106 through one or more liquid injection tubes 111. In one embodiment, the liquid injection tubes 111 may be coupled to the cartridge receiver 105 with an O-ring or similar seal, and the cartridge receiver 105 may be coupled to the liquid pump 126 by one or more liquid lines. The liquid injection tubes 111 are configured to disperse a liquid within the liquid permeable material 110, such that the liquid and the chemical hydride react to release hydrogen gas. In one embodiment, the cartridge 106 is oriented vertically, and the liquid injection tubes 111 are configured to fill the cartridge 106 with liquid from the bottom of the cartridge 106. In a further embodiment, the cartridge 106 is oriented horizontally, and the liquid injection tubes 111 are configured to evenly disperse liquid in the horizontal cartridge 106. In one embodiment, the cartridge 106 may comprise a plurality of liquid injection tubes 111. In another embodiment, the cartridge 106 includes one or more switching valves allowing liquid to be selectively injected through one or more liquid injection tubes and not other liquid injection tubes.

In one embodiment, the cooling module 112 is coupled to the cartridge receiver 105. The cooling module 112 is configured to disperse the heat produced by the chemical reaction between the liquid and the chemical hydride, conducting heat away from the cartridge 106. In one embodiment, the cooling module 112 includes low power fans that provide high airflows. In a further embodiment, the electrical and control system 103 may adjust the airflow from the cooling module 112 according to the temperature of the cartridge 106 as measured by the temperature sensor 118 to reduce parasitic power losses.

In another embodiment, the cooling module 112 comprises one or more blowers that are not affected by backpressure within the cartridge receiver 105. The cooling module 112 is configured to maintain a higher air pressure than an axial fan. One or more forms, guides, manifolds, or heat dams may be used to control and direct the flow of air around the cartridge 106. In a further embodiment, the cooling module 112 may comprise a pump configured to pump a fluid such as water around the cartridge 106 to facilitate a heat transfer between the cartridge and the fluid. The liquid pump may pump the fluid through tubing, pipes, or through channels in the housing 105 and/or in the cartridge 106. A heat sink comprising a metal, graphite, or other thermally conductive material may also be used.

In one embodiment, one or more hydrogen ports 114 are integrated with the alignment structures 108 on the cartridge 106. In a further embodiment, the hydrogen ports 114 are in fluid communication with one or more port connectors in the cartridge receiver 105. The hydrogen port connectors in the cartridge receiver 105 may include seals or O-rings.

In one embodiment, hydrogen gas exiting the inside of the cartridge 106 passes through a hydrogen cleaning system 116. In one embodiment, the hydrogen cleaning system 116 is integrated with the cartridge 106, or with a separate similar cartridge. In this manner, the hydrogen cleaning system 116 is replaced when the cartridge 106 is replaced, or when the hydrogen cleaning system 116 is in need of replacement. The hydrogen cleaning system 116, in one embodiment is located near the top of the cartridge 106 between the hydrogen ports 114 and the liquid permeable material 108. In another embodiment, the hydrogen cleaning system 116 is located external to, and downstream of, the cartridge 106. The hydrogen cleaning system 116 is configured to remove impurities such as hydrocarbons or other organic compounds, water vapor, dissolved or solid salts, or other impurities from the generated hydrogen gas. The hydrogen cleaning system 116 may comprise one or more individual filters, condensers, and/or coalescers comprising material suitable for filtering impurities from hydrogen gas. The hydrogen cleaning system 116 may also comprise a particulate filter configured to remove particles greater than a predefined size from the hydrogen gas. In one embodiment, the predefined size is about 5 microns.

In one embodiment, the temperature sensor 118 is configured to monitor the temperature of the cartridge 106 and the cartridge receiver 105. The temperature sensor 118 may make contact with, be disposed within, or otherwise read the temperature of the cartridge receiver 105 and/or the cartridge 106. The temperature that the temperature sensor 118 reads may cause the electrical and control system 103 to activate or deactivate the cooling module 112 or adjust other system variables to meet predetermined safety and usability standards.

In one embodiment, one or more cartridge sensors 120 determine the presence or absence of the cartridge 106. In a further embodiment, the cartridge sensors 120 may also determine whether the cartridge 106 is properly aligned for operation. The cartridge sensors 120, in one embodiment, may comprise a full insertion module that is configured to prevent operation of the system 100 in response to an improper insertion of the cartridge 106. The cartridge sensors 120 may be one or more manual switches, optical sensors, magnetic sensors, or other types of sensors capable of determining when the cartridge 106 is present. Preferably, the cartridge sensors 120 are optical sensors. Optical cartridge sensors 120 may be easier to position and calibrate during the manufacturing process and provide precise measurements without wearing over time as may occur with mechanical switches. In a further embodiment, the cartridge sensors 120 are also configured to determine when the receiver lid 107 is properly closed. In one embodiment, the cartridge 106 is configured to prevent the receiver lid 107, the outer housing 104, and/or another cover from fully closing when the cartridge 106 is improperly inserted in the cartridge receiver 105. The cartridge sensors 120 may comprise multiple cartridge sensors in various positions in or around the cartridge 106, and the cartridge receiver 105, and the receiver lid 107.

In one embodiment, the system 100 is configured to prevent hydrogen production unless one or more system sensors determine that the system 100 is in a proper system state. The one or more system sensors may be selected from the group consisting of the temperature sensors 118, 164, the cartridge sensor 120, the hydrogen pressures sensors 132, 144, and other system state sensors. In one embodiment, the system 100 prevents hydrogen production until the cartridge 106 is detected as present. In one embodiment, the electrical and control system 103 controls the hydrogen production based on inputs from one or more system sensors.

In one embodiment, the cartridge 106 includes an RFID tag 122 or other identifying device. The RFID tag 122 or other identifying device may be embedded in, mounted on, or otherwise coupled to the cartridge 106 such that it is readable by the RFID sensor 124 coupled to the cartridge receiver 105. In a further embodiment, the RFID tag 122 includes a unique cartridge identification number. By uniquely identifying each cartridge 106, the system 100 may provide usage statistics to the user, including alerts when the cartridge 106 is low on fuel and when the cartridge 106 must be replaced, even when the cartridge 106 is removed from the system 100 prior to exhaustion and later returned to the system 100.

In one embodiment, the system 100 stores usage information for one or more cartridges 106 corresponding to the unique cartridge identification number associated with each cartridge 106. For example, the electrical and control system 103 may store the usage information. Usage information, including the amount of fuel remaining in the cartridge 106, may be collected by monitoring the amount of liquid injected into the cartridge 106, by monitoring the amount of hydrogen that has exited the cartridge 106, or by performing one or more calculations based on electrical power supplied by the system 100 to estimate an amount of remaining fuel. Because the amount of reactants within the cartridge 106 is known, and the amount of reactant used with each pulse of liquid injected is known, a chemical reaction calculation can be used to determine how much hydride reactant has been used, and how much hydride reactant remains. In one embodiment, the electrical and control system 103 adjusts one or more system control parameters based on the usage information corresponding to a particular cartridge 106.

In one embodiment, a liquid is pumped into the cartridge 106 through the one or more liquid injection tubes 111 by the liquid pump 126. In one embodiment, the liquid pump 126 is configured to pump a liquid such as water in discrete pulses, according to a dynamic pulse rate determined by the hydrogen production or pressure demand and the power load. Pumping a liquid at variable pulse rates provides very fine control over the amount of the liquid supplied. In one embodiment, the pulse rate is determined using one or more mathematical or statistical curves. In a further embodiment, the pulse rate is determined using a hydrogen pressure curve, and an electrical power demand curve, each curve having individual slopes and magnitudes. In one embodiment, the magnitudes at varying points along the curves signify an amount of time between pulses. The magnitudes may be positive or negative, with positive values signifying a slower pulse rate, and negative values signifying a faster pulse rate. When multiple curves are used, the magnitudes from each curve at the point on the curve corresponding to the system state may be added together to determine the pulse rate.

The liquid pump 126 is a pump capable of pumping a liquid such as water into the cartridge 106 through the one or more injection tubes 111. In one embodiment, the liquid pump 126 is a peristaltic pump. Use of a peristaltic pump is advantageous because a peristaltic pump cannot contaminate the liquid that it pumps, is inexpensive to manufacture, and pumps a consistent, discrete amount of liquid in each pulse. Advantageously, a peristaltic pump provides a consistent and discrete amount of liquid regardless of the backpressure in the liquid in the injection tube 111.

In one embodiment, the amount of hydrogen gas produced, and the potential amount of hydrogen production remaining in the cartridge 106 may be determined by tracking the number of pulses made by the pump 126. The electrical and control system 103 may determine the remaining hydrogen potential of the cartridge 106 based on the amount of chemical hydride in the cartridge 106, the size of each pulse that the liquid pump 126 pumps, and the number of pulses that the liquid pump 126 has pumped. The liquid pump 126 pulse quantity may be defined based on the hydrogen gas requirements of the fuel cell 146. In one embodiment, the liquid pump 126 pulse quantity is between about 75 μL to 100 μL. In addition, a peristaltic pump 126 allows the control system 103 to reverse the direction of the pump to withdraw liquid from the cartridge 106 and thereby slow the production of hydrogen. This fine degree of control allows the production of hydrogen to more closely match the demands of the fuel cell 102.

The liquid pump 126 pumps a liquid that is stored in the liquid reservoir 128. In another embodiment, a user may add liquid to the liquid reservoir 128 manually. In one embodiment, the liquid level sensor 129 monitors the liquid level of the liquid reservoir 128. The liquid level sensor 129 may be an ultrasonic sensor, a float sensor, a magnetic sensor, pneumatic sensor, a conductive sensor, a capacitance sensor, a point level sensor, a laser sensor, an optical sensor, or another liquid level sensor. In a further embodiment, the liquid level sensor 129 comprises a window into the liquid reservoir 128 that allows a user to visually monitor the liquid level.

In one embodiment, the generated hydrogen passes through the check valve 130. The check valve 130 allows hydrogen to exit the cartridge 106, but prevents hydrogen from returning into the cartridge 106. The check valve 130 also prevents hydrogen from exiting the system 100 when the cartridge 106 has been removed. This conserves hydrogen, provides a safety check for the user, and allows an amount of hydrogen to be stored in the system 100 for later use. The check valve 130 is in inline fluid communication with the hydrogen ports 114. In one embodiment, a second check valve is integrated into the cartridge receiver 105. The check valve 130 may be a silicone duckbill type valve, a diaphragm type valve, or another type of check valve.

In one embodiment, a hydrogen pressure sensor 132 downstream from the check valve 130 measures the gas pressure of the hydrogen. In a further embodiment, the hydrogen pressure sensor 132 measures the hydrogen pressure in the system upstream of the hydrogen regulator 142. The hydrogen pressure sensor 132 may be used for safety purposes and/or to monitor hydrogen generation rates. In one embodiment, the electrical and control system 103 may use the pressure values measured by the hydrogen pressure sensor 132 to determine a pump pulse rate for the liquid pump 126 using a pressure curve, as described above. In general, the electrical and control system 103 may increase the pulse rate for low pressure measurements, and decrease the pulse rate for high pressure measurements. More curves, such as power demand or other curves, may also be factored into determining an optimal pulse rate. Monitoring the pressure using the pressure sensor 132 also allows the system 100 to adjust the pressure before it reaches unsafe levels. If pressure is above a threshold gas pressure such as a predetermined safety value, the electrical and control system 103 may vent hydrogen out through the hydrogen purge valve 166 to return the system to a safe pressure.

In one embodiment, the mechanical valve 133 is positioned upstream of the hydrogen pressure regulator 142. In one embodiment, the mechanical valve 133 is a mechanical valve configured to automatically release gas pressure when the pressure is greater than a predetermined threshold gas pressure. In one embodiment, the predetermined threshold gas pressure associated with the mechanical valve 133 is higher than the threshold gas pressure or safety value associated with the hydrogen pressure sensor 132 described above. In one embodiment, the predetermined threshold gas pressure associated with the mechanical valve 133 is about 30 pounds per square inch gauged (psig) to 150 psig or higher, and the predetermined safety value associated with the hydrogen pressure sensor 132 is between about 15 to 30 psig or higher depending on system design requirements, such as 100 psig. In another embodiment, the predetermined threshold gas pressure associated with the mechanical valve 133 is higher than the predetermined safety value associated with the hydrogen pressure sensor 132.

In one embodiment, one or more other system components are configured to release hydrogen pressure in the event that the hydrogen pressure regulator 142 fails, a system component clogs, the system 100 generates excess hydrogen, or another high pressure event occurs, and an internal system gas pressure rises above a threshold gas pressure. The other system components may include seals, o-rings, hose fittings or joints, the liquid pump 126, or other mechanical components or connections. Multiple levels of pressure release provide added safety to the user, and ensure that the system 100 remains at a safe pressure, with no danger of explosions or other damage to the system 100 or to the user. Low pressure systems are not only safer than higher pressure systems, but in general they have lower material and construction costs.

In one embodiment, the liquid reservoir 128 has a liquid condenser 138. The liquid condenser 138 removes liquid from air and other gasses that enter the liquid reservoir 128. In one embodiment, water condenses on frit or other material in the condenser 138. In a further embodiment, the air and other gasses exit the system through the pressure control valve 140 after passing through the condenser 138.

In one embodiment, the hydrogen passes from the hydrogen cleaning system 116 to the hybrid hydrogen fuel cell system 102. In one embodiment the hybrid hydrogen fuel cell system 102 has a hydrogen pressure regulator 142, a hydrogen pressure sensor 144, a hydrogen fuel cell stack assembly 146, one or more air filters 150, one or more air pumps 152, an air humidifier 156, a modular stack 158, a hydrogen humidifier 160, one or more cooling fans 162, a temperature sensor 164, a hydrogen purge valve 166, and one or more power storage devices 168.

In one embodiment, the hydrogen regulator 142 regulates the flow of hydrogen into the hydrogen fuel cell stack assembly 146 from the hydrogen cleaning system 116. The hydrogen regulator 142 cooperates with the check valve 130 to store hydrogen between the check valve 130 and the hydrogen regulator 142, even between uses of the system 100. The hydrogen regulator 142 releases a controlled amount of hydrogen into the fuel cell stack assembly 146, maintaining a predetermined gas pressure in the fuel cell 146. In one embodiment, the predetermined gas pressure in the fuel cell 146 is about 7 psi.

In one embodiment, the hydrogen pressure sensor 144 measures the gas pressure of the hydrogen in the system 100 downstream of the hydrogen regulator 142, (i.e. within the fuel cell system 102). The hydrogen pressure sensor 144 may be used for safety purposes, and/or to monitor hydrogen use by the fuel cell 146. If pressure is above a predetermined safety value, hydrogen may be vented from the system through the hydrogen purge valve 166 to return the pressure to a safe level, as described above. In one embodiment, if the pressure is below the predetermined fuel cell gas pressure described above, the hydrogen regulator 142 releases more hydrogen into the fuel cell stack 146.

The hydrogen fuel cell stack assembly 146 creates electric power from a flow of hydrogen and air, as is known in the art. In general, each fuel cell 158 in the hydrogen fuel cell stack assembly 146 has a proton exchange membrane (PEM), an anode, a cathode, and a catalyst. A micro-layer of the catalyst is usually coated onto carbon paper, cloth, or another gas diffusion layer, and positioned adjacent to the PEM, on both sides. The anode, the negative post of the fuel cell 158, is positioned to one side of the catalyst and PEM, and the cathode, the positive post of the fuel cell, is positioned to the other side. The hydrogen is pumped through channels in the anode, and oxygen, usually in the form of ambient air, is pumped through channels in the cathode. The catalyst facilitates a reaction causing the hydrogen gas to split into two H+ ions and two electrons. The electrons are conducted through the anode to the external circuit, and back from the external circuit to the cathode. The catalyst also facilitates a reaction causing the oxygen molecules in the air to split into two oxygen ions, each having a negative charge. This negative charge draws the H+ ions through the PEM, where two H+ ions bond with an oxygen ion and two electrons to form a water molecule.

In one embodiment, one or more air filters 150 are configured to filter air for use by the fuel cell stack assembly 146. In one embodiment, one or more air pumps 152 draw air into the system 100 through the air filters 150. The air pumps 152 may be diaphragm pumps, or other types of air pumps capable of maintaining an air pressure to match the hydrogen pressure in the fuel cell, for a maximum power density in the fuel cell stack 146. In one embodiment, the air pumps 152 are configured to increase or decrease the air flow in response to a signal from the electrical and control system 103. The electrical and control system 103 may send the activating signal in response to a determined electrical load on the system 100. Varying the air flow as a function of the electrical load reduces parasitic power losses and improves system performance at power levels below the maximum. In one embodiment, the one or more air pumps 152 have multiple air pumping capabilities configured to optimize the amount of air delivered to the fuel cell stack 146. For example, a smaller capacity air pump 152 may be activated during a low power demand state, a larger capacity air pump 152 may be activated during a medium power demand state, and both the smaller and the larger capacity air pumps 152 may be activated during a high power demand state.

In one embodiment, the air humidifier 156 humidifies the air entering the fuel cell stack 146. Adding moisture to the air keeps the PEMs in each of the fuel cells 158 moist. Partially dehydrated PEMs decrease the power density of the fuel cell stack 146. Moisture decreases the resistance for the H+ ions passing through the PEM, increasing the power density. In one embodiment, moist air exiting the fuel cell stack 146 flows past one side of a membrane within the air humidifier 156 before exiting the fuel cell stack 146, while dry air flows past the other side of the membrane as the dry air enters the fuel cell stack 146. Water is selectively drawn through the membrane from the wet side to the dry side, humidifying the air before it enters the fuel cell stack 158.

In one embodiment, the hydrogen humidifier 160 is configured to humidify the hydrogen entering the fuel cell stack 146, such that the PEM remains moist. This is useful if the fuel cell stack 146 is being run at a very high power density, or at a very high temperature, and the moisture already in the hydrogen is not enough to keep the PEM moist. The hydrogen humidifier 160 may be configured in a similar manner as the air humidifier 156, with hydrogen flowing into the fuel cell stack 146 on one side of a membrane within the hydrogen humidifier 160, and moist air flowing out of the fuel cell stack 146 on the other side of the membrane, the membrane selectively allowing water to pass through to humidify the hydrogen. The moist hydrogen will moisten the anode side of the PEMs, while the moist air from the air humidifier 156 will moisten the cathode side of the PEMs. In one embodiment, the air humidifier 156 and/or the hydrogen humidifier 160 may be integrated with each other and/or with the fuel cell stack 158.

In one embodiment, the one or more cooling fans 162 prevent the fuel cell stack 158 from overheating. The electrical and control system 103 controls the operation and speed of the cooling fans 162. Separating the cooling system 162 from the fuel cell stack air supply system decreases the dehydration of the PEM since the air supply can be kept at a much lower flow than is required for cooling. A fuel cell system with separated cooling and air supply systems are referred to as closed cathode systems. In one embodiment, the cooling fans 162 are low power fans that provide high airflows. In a further embodiment, the airflow from the cooling fans 162 may be adjusted according to the temperature of the fuel cell stack 158 to reduce parasitic power losses. In another embodiment, the one or more cooling fans 162 comprise one or more blowers configured to maintain a higher air pressure than an axial fan. One or more forms, guides, ducts, baffles, manifolds, or heat dams may be used to control and direct the flow of air, or to maintain a predefined air pressure in and around the fuel cell stack 146.

In one embodiment, the temperature sensor 164 measures the temperature of the fuel cell stack 162. As described above, in one embodiment the cooling fans 162 may be activated based at least in part on the temperature that the temperature sensor 164 measures. In a further embodiment, the electrical and control system 103 is configured to shutdown the system 100 and to notify the user if the temperature sensor 164 measures a temperature higher than a predetermined unsafe temperature value.

In one embodiment, a hydrogen purge valve 166 is coupled to the fuel cell stack 146. The hydrogen purge valve 166 vents hydrogen from the fuel cell stack 146. The hydrogen purge valve 166 may be used to vent hydrogen when pressures reach unsafe levels, as measured by the hydrogen pressure sensors 132, 144 described above, or routinely to keep the fuel cells 158 in good condition by preventing corrosion of the catalyst. The electrical and control system 103 may send a purge signal to the hydrogen purge valve 166 when the pressure reaches an unsafe level, or when the electrical power produced by the fuel cell stack 146 is below a predefined level. In one embodiment, the hydrogen exiting the fuel cell stack 158 through the hydrogen purge valve 166 and the moist air that has exited the fuel cell stack 158 are sent to the liquid reservoir 128 and passed through the water condenser 138 to recycle the water formed in the reaction in the fuel cell stack 146 for reuse.

In one embodiment, one or more power storage devices 168 are coupled electrically to the fuel cell stack 146. In one embodiment, the power storage devices 168 are rechargeable, and are trickle-charged by the fuel cell stack 146 when it is not in use or after the load has been disconnected to use up excess hydrogen produced by the system 100 during shutdown. The power storage devices 168 provide instantaneous power to the load during a startup phase for the system 100. This means that a load connected to the system 100 will have instantaneous power, and will not have to wait for the hydrogen generation system 101 to begin generating hydrogen, or for the fuel cell stack 146 to begin producing electricity before receiving power.

In one embodiment, the power storage devices 168 are configured to heat the fuel cell stack 146 in cold environments to allow rapid startup of the fuel cell stack 146. The power storage devices 168 may heat the fuel cell stack 146 using a heating coil or other heated wire, or by using another electric heating method. In one embodiment, the power storage device 168 is coupled to the fuel cell stack 146 in parallel, and acts to level the load on the fuel cell stack 146 so that the fuel cell stack 146 can operate at its most efficient power level without constantly varying its output based on the load. The power storage devices 168 will supplement the power generated by the fuel cell stack 146 during a spike in the electrical power drawn by the load. The power storage devices 168 may be selected from a group consisting of batteries, such as sealed lead acid batteries, lithium ion (Li-ion) batteries, nickel metal hydride (NiMH) batteries, or a variety of rechargeable batteries, a capacitor, a super capacitor, and other devices capable of storing electric power. In one embodiment, power storage devices 168 are selected for use with power capacities that may be larger than are necessary to supplement the fuel cell stack 146 in order to avoid deep cycling of the power storage devices 168 and to increase the life of the power storage devices 168.

In one embodiment, the electrical and control system 103 is coupled for electrical power and control signal communication with one or more of the sensors, valves, and other components of the system 100. In one embodiment, the electrical and control system 103 comprises one or more voltage and current sensors 170, a direct current (DC) to DC converter 172, a circuit breaker 174, a ground fault circuit interrupter (GFCI) device 176, an electronic switch 178, a DC outlet 180, an AC inverter 181, an AC outlet 182, a circuit breaker switch 184, a GFCI switch 186, a display 188, a keypad 190, a control system 192, a computer communication interface 194, and a control bus 196.

In one embodiment, the voltage and current sensors 170 are configured to measure the voltage and the current at both poles of the power storage device 168. The electrical and control system 103 uses the voltage and the current at each pole of the power storage device 168 to determine the charge level of the power storage device 168. Based on the measurements of the voltage and current sensors 170 the electrical and control system 103 determines whether to charge the power storage device 168 or draw on the power storage device 168 to supplement or proxy for the fuel cell stack 146. The electrical and control system 103 also provides the power status of the battery to the user.

In one embodiment, the DC to DC converter 172 is configured to convert the variable voltage of the fuel cell stack 146 circuit to a substantially constant voltage. In one embodiment, the substantially constant voltage is a standard voltage, such as 6 Volts, 9 Volts, 12 Volts, 14 Volts, 24 Volts, or the like. In one embodiment, a voltage regulator may be used in place of the DC to DC converter 172. In general, use of the DC to DC converter 172 results in less power loss than a voltage regulator. The DC to DC converter 172 may provide electric power to the electrical components of the system 100 and to an electrical load that is coupled to the system 100.

In one embodiment, the circuit breaker 174 interrupts the electric circuit in response to an overload in the circuit. An overload in the circuit may occur if the electrical load requires more current than the system 100 can provide. In one embodiment, the rating of the circuit breaker 174 is determined by the electric power generating capabilities of the system 100. In one embodiment, the circuit breaker 174 is a standard rated circuit breaker rated for the current level of the electrical and control system 103. In one embodiment, the circuit breaker switch 184 is configured to reset the circuit breaker 174 after the circuit breaker 174 interrupts the circuit.

In one embodiment, the GFCI device 176 interrupts the electric circuit in response to an electrical short in the circuit. The GFCI device 176 can interrupt the electric circuit more quickly than the circuit breaker 174. The GFCI device 176 is configured to detect a difference in the amount of current entering the circuit and the amount of current exiting the circuit, indicating a short circuit or current leak. In one embodiment, the GFCI device 176 is able to sense a current mismatch as small as 4 or 5 milliamps, and can react as quickly as one-thirtieth of a second to the current mismatch. In one embodiment, the GFCI switch 186 is configured to reset the GFCI device 176 after the GFCI device 176 interrupts the circuit.

In one embodiment, electronic switch 178 disconnects the load from electric power, without disconnecting the rest of the circuit. In one embodiment, the electronic switch 178 disconnects the load after a user initiated a power down phase of the system. During a shutdown state, the system 100 may activate the electronic switch 178 and disconnect the load continue to generate electricity to charge the power storage device 168 and to use excess hydrogen.

In one embodiment, the DC outlet 180 provides an outlet or plug interface for supplying DC power to DC devices. In one embodiment, the DC power has a standard DC voltage. In one embodiment, the standard DC voltage is about 9 to 15 Volts DC. In a further embodiment, the DC outlet 180 is a “cigarette lighter” type plug, similar to the DC outlets found in many automobiles.

In one embodiment, the AC inverter 181 converts DC power from the DC to DC converter 176 to AC power. In one embodiment, the AC inverter 181 converts the DC power to AC power having a standard AC voltage. The standard AC voltage may be chosen based on region, or the intended use of the system 100. In one embodiment, the standard AC voltage is about 110 to 120 Volts. In another embodiment, the standard AC voltage is about 220 to 240 Volts. In one embodiment, the AC inverter 181 converts the DC power to AC power having a standard frequency, such as 50 Hz or 60 Hz. The standard frequency may also be selected based on region, or by intended use, such as 16.7 Hz or 400 Hz.

In one embodiment, the AC outlet 182 provides an outlet or plug interface for supplying AC power from the AC inverter 181 to AC devices. In one embodiment, the AC outlet 182 is configured as a standard AC outlet according to a geographical region. In a further embodiment, the AC outlet 182 may comprise multiple AC outlets or plug interfaces.

In one embodiment, the display 188 is configured to communicate information to a user. The display 188 may be a liquid crystal display (LCD), a light emitting diode (LED) display, an organic LED (OLED) display, a cathode ray tube (CRT) display, or another display means capable of signaling a user. In one embodiment, the display 188 is configured to communicate error messages to a user. In a further embodiment, the display 188 is configured to communicate the amount of power stored by the power storage device 168 to a user. In another embodiment, the display 188 is configured to communicate the usage status of the cartridge 106 to a user.

In one embodiment, the keypad 190 is configured to receive input from a user. In one embodiment, the user is a technician, and the keypad 190 is configured to facilitate system error diagnosis or troubleshooting by the technician. The input may be configured to signal the system 100 to begin a start up or shut down phase, to navigate messages, options, or menus displayed on the display 188, to signal the selection of a menu item by the user, or to communicate error, troubleshooting, or other information to the system 100. The keypad 190 may comprise one or more keys, numeric keypad, buttons, click-wheels, or the like.

In one embodiment, the control system 192 is configured to control one or more components of the system 100. The control system 192 may be an integrated circuit such as a micro-processor, an application specific integrated circuit (ASIC), a field programmable gate array (FPGA), an embedded controller, or the like and related control circuitry. The control system 192 communicates with the hydrogen pressure sensor 132, the temperature sensor 118, the RFID sensor 124, the optical sensor 120, the liquid injection pump 126, the level detector 129, the air pump 152, the hydrogen pressure sensor 144, the electrical sensors 170, the temperature sensor 164, the display 188, the keypad 190, and/or other components.

In one embodiment, the control system 192 uses a control bus 196 to communicate with the components. The control bus 196 may be one or more wires, or another communications medium providing control commands and data in series or parallel. The control system 192 may communicate on the bus 196 using digital or analog communications. The control system 192 may monitor and optimize system efficiency and system safety, as discussed above. In one embodiment, the control system 192 may store one or more system status messages, performance data, or statistics in a log that may be accessed by a user using the display 190 or the computer communication interface 194. In one embodiment, the control system 192 and other circuitry are positioned to prevent shorts and fire due to water within the outer housing 104. For example, in one embodiment, the control system 192 and other circuitry are position towards the top of the system 100.

In one embodiment, the computer communication interface 194 is configured to interface the control system 192 with a computer. The computer communication interface 194 may comprise one or more ports, terminals, adapters, sockets, or plugs, such as a serial port, an Ethernet port, a universal serial bus (USB) port, or other communication port. In one embodiment, a computer may use the computer communication interface 194 to access system logs, performance data, system status, to change system settings, or to program the control system 192.

In one embodiment, the outer housing 104 is configured to enclose and protect the system 100. The outer housing 104 comprises a durable material such as metal, plastic, and the like. In one embodiment, the outer housing 104 is a lightweight material to increase the portability of the system 100. In a further embodiment, the outer housing 104 has a hole or a window to facilitate monitoring of the liquid level in the liquid reservoir 128 by the user. In a further embodiment, the housing 104 is further configured to provide electronic frequency shielding to components of the electric and control system 103.

FIG. 2 illustrates one embodiment of a cartridge 200 that is substantially similar to the cartridge 106 of FIG. 1. The cartridge 200 is an enclosure capable of containing a fluid such as a gas or a liquid. Suitable examples of fluids include water, air, gases such as hydrogen, and the like. In certain embodiments, the cartridge 200 includes a single outlet port for permitting a fluid to exit the cartridge 200.

In other embodiments, the cartridge 200 includes a one or more outlet ports for permitting a fluid to exit the cartridge 200 and one or more inlet ports for permitting a fluid to enter the cartridge 200. It should be noted that the cartridge 200 may enclose a variety of fluid processing components including a fluid filtration component such as a filter, a fluid generation component such as byproducts of a chemical reaction, a fluid consumption component such as a fuelcell, and a fluid containment component such as a hydrogen ballast. Consequently, those in the art recognize that the cartridge 200 may comprise a cartridge 200 containing a fluid generating reaction such as a hydrogen generation reaction. Alternatively, the cartridge 200 may receive one or more fluid streams and deliver one or more fluid streams to another component or container in a system. For example, the cartridge 200 may comprise a filtration component that receives a fluid stream and delivers a modified version of the fluid stream. Alternatively, the cartridge 200 may serve as a regulator of a fluid flow receiving one or more fluid streams and delivering one or more fluid streams to another component or container in a system. Alternatively, the cartridge 200 may serve as a fluid ballast for a fluid flow receiving one or more fluid streams and delivering one or more fluid streams to another component or container in a system. Alternatively, the cartridge 200 may house a fuelcell that receives one or more fluid streams and delivers one or more fluid streams and an electric current to another component in a system.

The cartridge 200 may include a tubular body or housing 202, which in one embodiment may range from about 1 to 5 inches in diameter and from about 4 to 12 inches in length. The housing 202 is not limited to any particular cross-sectional shape or any particular dimensions, but may have a circular cross-sectional shape.

In one embodiment, the housing 202 is formed of a material such as aluminum which has sufficient strength, is comparatively light, and has good heat transfer characteristics. However, many substitute materials will be readily apparent to those skilled in the art, including steel, stainless steel, copper, carbon fiber epoxy composites, fiberglass epoxy composites, PEEK, polysulfone derivatives, polypropylene, PVC, or other suitable materials. In one embodiment, the cartridge 200 also has a cartridge interface 204 allowing the cartridge 200 to be easily positioned and locked into place with other components of the overall hydrogen generation system 100 as described above.

In one embodiment, the cartridge interface 204 includes an alignment structure 208, one or more hydrogen ports 212, and one or more fluid ports 216. In one embodiment, the hydrogen ports 212 and the fluid ports 216 may also comprise one or more self sealing devices know to the art. The alignment structure 208 or other locking feature is configured to ensure that the cartridge interface 204 can only engage the cartridge receiver 105 in one orientation or alignment. In one embodiment, the housing 202 includes a crimp 224, substantially circumscribing the housing 202 near the open end of the housing 202. The crimp 224 secures the housing 202 to the cartridge interface 204. In addition, the crimp 224 is configured to safely release internal hydrogen gas and water in response to a dangerously high gas pressure build up within the housing 202. In further embodiments, other securing methods such as threading, glue or other adhesives, welding, or the like may secure the cartridge interface 204 to the housing 202.

In one embodiment, the one or more hydrogen ports 212 and the one or more fluid ports 216 are substantially similar to the one or more hydrogen ports 114 and the one or more liquid injection tubes 111 described above. In one embodiment, the hydrogen ports 212 and the fluid ports 216 are about one sixteenth of an inch. In one embodiment, one or more fluid injection tubes 218 extend into the interior of the cartridge housing 202 which holds a solid reactant (as explained in more detail below) from the one or more fluid ports 216. In one embodiment, the injection tubes 218 may extend into the housing 202 at least half of the length of the housing 202, in other embodiments the injection tubes 30 may extend less than half the housing's length. In one embodiment, the liquid injection tubes 218 have an inside diameter of about 1 mm. In a further embodiment, the liquid injection tubes 218 have an inside diameter ranging from about 0.5 to 5.0 mm.

The injection tubes 218 may be made of aluminum, brass, or other metal, PTFE, Nylon®, or other high temperature polymers. In one embodiment, a series of liquid distribution apertures will be formed along the length of the liquid injection tubes 218. In another embodiment, the cartridge 200 is oriented vertically, and the injection tubes 218 are configured to extend substantially to the base of the cartridge 200, such that liquid successively fills the cartridge 200 from the base towards the cartridge interface 204. In this manner fluids may also be pumped out of the cartridge 200 through the injection tubes 218 to further control hydrogen production and to maintain a safe hydrogen pressure.

FIG. 3A illustrates a further embodiment of a cartridge 300. As suggested above, one embodiment of the cartridge 300 will contain a solid reactant such as an anhydrous chemical hydride. In one embodiment, a chemical hydride may be considered a reducing compound containing hydrogen that generates hydrogen gas when it reacts with water or other oxidizing agents. Chemical hydrides may comprise organic or inorganic compounds. Various examples of chemical hydrides are disclosed in U.S. patent application Ser. No. 11/829,019 filed Jul. 26, 2007, which is incorporated herein by reference in its entirety. Nonlimiting examples of chemical hydrides may include sodium borohydride, lithium borohydride, lithium aluminum hydride, lithium hydride, sodium hydride, and calcium hydride.

In one embodiment, the chemical hydride reactant is enclosed within a liquid permeable material, or fabric pouch 302. As used herein, “fabric” includes not only textile materials, but also includes paper based porous materials that may be used for filtration purposes. One embodiment of the fabric comprises a porous material which can maintain structural integrity at temperatures ranging from about −20° C. to about 200° C., and a pH ranging from about 4 to about 14.

Suitable fabrics may include but are not limited to woven or nonwoven Nylon, Rayon, polyester, porous filter paper, or blends of these materials. In one embodiment, the material for the pouch 302 may be selected for optimal thickness, density, and liquid retention. In one embodiment, the cartridge 300 is in a vertical configuration and the pouch 302 comprises a material with minimal liquid retention, such that the weight of the liquid retained is less than about 10 times the weight of the material itself. The material also includes little or no wicking capabilities. In a further embodiment, the cartridge 300 is in a horizontal configuration and a material 302 is selected with greater liquid retention ability and some wicking ability.

The liquid retention and wicking potential of the pouch 302 affect where the chemical reaction between the liquid and the chemical hydride occurs. Low liquid retention and wicking potential helps keep the chemical reaction at or below the liquid fill level in the cartridge 300. If the liquid retention and wicking potential are higher, the pouch 302 wicks and retains the liquid such that the chemical reaction can occur above the fill level of the cartridge 300. Selection of a material for the pouch 302 may be based on the configuration of the cartridge 300, the injection tubes 304, and the chemical hydride and activating agent in use, in order to more precisely control the chemical reaction within the cartridge 300.

Other relevant factors may include liquid permeability, porosity, chemical reactivity, and temperature stability between about 150° C. and about 250° C., depending on the chemical hydride, activating agent, and liquid injection system 304 in use. A suitable thickness for the material for the pouch 302, in one embodiment, may be between about 0.002 inches and 0.01 inches. A suitable density may be less than about 0.05 grams per square inch.

In one exemplary embodiment, the pouch 302 comprises a material having a thickness of about 0.0043 inches, a density of about 57.9 grams per square meter, is water permeable, having a pore size below about 0.0025 inches, is chemically resistant in basic and acidic solutions of about pH 4 to about pH 13, is stable in temperatures up to about 180° C., and retains only about 4 times its own weight in water. Other combinations of material properties such as thickness, density, and liquid retention that are configured for stable hydrogen generation may also be used.

In one embodiment, the fabric pouch 302 is comparatively thin having a substantially greater area than thickness. The pouch 302 may be formed in any conventional manner. For example, viewing FIG. 3B, it can be seen how two rectangular sheets of fabric material 314 and 316 may be sealed along three edges (for example by stitching 310 or other sealing methods) and segmented into 0.25 to 2 inch sections 318 (also by stitching) to leave open ends 312. The series of sections 318 thus formed are filled with a fine grain chemical hydride (described below) and sealed along the fourth edge by stitching closed open ends 312.

An illustrative thickness of the pouch 302 (i.e., the thickness of sections 318 when unrolled and charged with a chemical hydride) may be approximately ¼ of an inch in one embodiment and its unrolled dimensions could be approximately 5.75 inches by 20 inches. Then the pouch 302 is rolled to a diameter sufficiently small to be inserted into tubular housing 300 as suggested in FIG. 3A (the cartridge interface 206 has been removed for purposes of clarity). The thickness of the pouch 302 and the unrolled dimensions may be determined based on the size of the cartridge 300, and the configuration of the pouch 302. The liquid injection tubes 304 are then carefully inserted between overlapping layers of the rolled pouch 302. In one embodiment, a liner (not shown) is also disposed within the housing 300 to protect the housing from corrosion and damage. The liner may be removable or permanent, and may serve to extend the life of the housing 300. In one embodiment, the liner is a bag or pouch consisting of a plastic or other inert material known in the art, and the liner is configured to withstand the temperatures associated with a hydrogen generating chemical reaction, and to protect the cartridge 300 from corrosion.

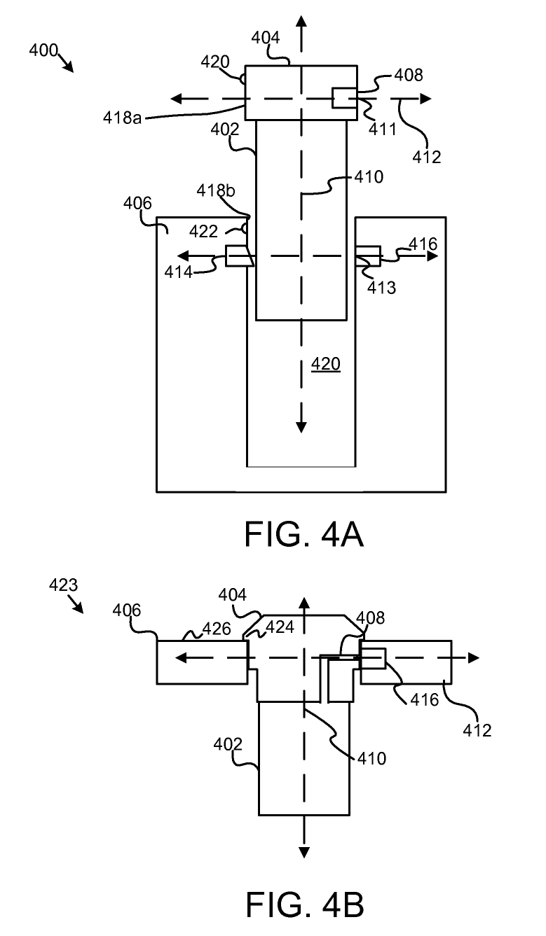

FIG. 4A illustrates a side view of one embodiment of a hydrogen generation system interface 400 according to the present invention. The hydrogen generation system interface 400 includes a cartridge 402, a cartridge interface 404, and a cartridge receiver 406. The hydrogen generation system interface 400 provides a fluid pathway for a flow of hydrogen generated by a hydrogen generation system.

The cartridge 402, in one embodiment, contains a hydride fuel. In certain embodiments, the cartridge 402 is configured to house a chemical hydride fuel and an activating agent, to receive liquid, to house a chemical reaction between the chemical hydride and the liquid which produces hydrogen gas, and to release the hydrogen. The cartridge 402, in another embodiment, may be configured to house other hydrogen producing reactions, other fluids, or other systems or components such as a hydrogen filtration system. One example of a hydrogen filtration system is the hydrogen cleaning system 116 of FIG. 1, described above.

In one embodiment, the cartridge 402 is cylindrical in shape. The cylindrical shape provides structural strength to withstand the internal pressures as hydrogen is produced. The cartridge 402 may comprise a material configured to withstand the heat and pressure of the chemical reaction. The material may also comprise a lightweight material selected to minimize the weight of the cartridge 402, such as a lightweight metal or metal alloy like aluminum, a plastic polymer, or other durable material. In another embodiment, the cartridge 402 comprises a stamped aluminum cylindrical cartridge.

The cartridge 402, in one embodiment, passes generated hydrogen to the cartridge interface 404. The cartridge 402 may include passages for the transfer of generated hydrogen, such as tubes, manifolds, channels, or the like. In one embodiment, the cartridge 402 includes a machined channel providing fluid communication between the interior of the cartridge 402 and the cartridge interface 404. In another embodiment, the cartridge 402 includes a formed channel providing fluid communication between the interior of the cartridge 402 and the cartridge interface 404, such as in an injection molding process.

The cartridge interface 404, in one embodiment, is attached to the cartridge 402 and includes at least one cartridge interface gas outlet port 408. The cartridge interface 404, in one embodiment, removably couples or secures the cartridge 402 to the cartridge receiver 406. In certain embodiments, the cartridge interface 404 engages the cartridge receiver 406 in response to the insertion of the cartridge 402 into a cavity 420 of the cartridge receiver 406. Insertion and removal of the cartridge 402 occurs along an insertion path 410, the insertion path 410 represented by the dashed arrow in FIG. 4.

The cartridge interface gas outlet port 408, in one embodiment, is in fluid communication with the interior of the cartridge 402 and provides a fluid pathway for a flow of hydrogen gas generated within the cartridge 402. In another embodiment, the cartridge interface gas outlet port 408 may comprise a cartridge interface fluid outlet port that provides a fluid pathway for a flow of another fluid, such as air, water, or other liquids and gasses. The cartridge interface gas outlet port 408 is oriented with an orientation angle 411 relative to an orthogonal plane 412. The orthogonal plane 412 is orthogonal to the insertion path 410.

In the illustrated embodiment, the interface gas outlet port 408 is oriented with an orientation angle 411 of about three degrees, meaning that the interface gas outlet port 408 orientation is three degrees from the orthogonal plane 412. In another embodiment, the interface gas outlet port 408 may have a different orientation angle 411, such as five degrees from the plane of the orthogonal plane 412. In certain embodiments, the interface gas outlet port 408 may have any orientation angle 411 from zero to 90 degrees in any direction from the orthogonal plane 412. In a further embodiment, the interface gas outlet port 408 may have any orientation angle 411 that is not equal to 90 degrees from the orthogonal plane 412, such that the interface gas outlet port 408 is nonparallel to the insertion path 410. In another embodiment, the interface gas outlet port 408 may have an orientation angle 411 from zero to 45 degrees in any direction from the orthogonal plane 412.

The cartridge interface 404 may comprise any material known in the art to withstand the pressures, temperatures, and stresses generated in hydrogen generation. In a further embodiment, the cartridge interface 404 also comprises a lightweight material, to keep the overall weight of the system to a minimum for added portability. In one embodiment, the cartridge interface 404 is a lightweight metal or metal alloy such as aluminum or the like. In a further embodiment, the cartridge receiver 105 comprises a fiberglass material, a plastic polymer material, a ceramic material, or another durable material.

In certain embodiments, the cartridge interface 404 is attached to the cartridge 402. In another embodiment, the cartridge interface 404 is formed as an integrated part of the cartridge 402. In one embodiment, the cartridge interface 404 and the cartridge 402 comprise a single structure.

The cartridge receiver 406, in one embodiment, receives the cartridge 402. The cartridge receiver 406 may be configured to interface with the cartridge interface 404 to receive a flow of hydrogen gas. In one embodiment, the cartridge receiver 406 includes a biasing member 414 and a receiver gas port 416.

The biasing member 414, in one embodiment, applies a force that acts to hold together the interface gas outlet port 408 and the receiver gas port 416. The biasing member 414 may removably secure the cartridge 402 to the cartridge receiver 406. In one embodiment, the biasing member 414 compresses in response to the insertion of the cartridge 402 into the cartridge receiver 406.

The biasing member 414 may comprise a compliant material, a spring, or the like. For example, the biasing member 414 may comprise a synthetic or natural rubber compound that compresses upon insertion of the cartridge 402 into the cartridge receiver 406, such as an elastomeric material. In another example, the biasing member 414 may comprise an interior wall of the cartridge receiver 406 or an extension, lever, ramp, nub, wedge, or the like extending from the interior wall, which elastically deforms upon insertion of the cartridge 402, applying a resulting force to the cartridge interface 404. The interior wall may be tapered. In another embodiment, the biasing member 414 may comprise at least a part of the cartridge interface 404. At least a part of the cartridge interface 404 may comprise a compliant material, as described above.

In one embodiment, the biasing member 414 is diametrically opposed to the receiver gas port 416. For example, the cartridge 402 may have a circular cross section, and the cartridge receiver 406 may have a corresponding substantially circular cross section. In this example, the biasing member 414 and the receiver gas port 416 may be along a common diameter of the substantially circular cross section of the cartridge receiver 406.

In another embodiment, the cartridge 402 and/or the cartridge receiver 406 may have a non-circular cross section. In this embodiment, a biasing member 414 diametrically opposed to the receiver gas port 416 applies a force substantially in line with the receiver gas port 416. For example, a cartridge receiver 406 with a substantially square cross section may have a biasing member 414 on a first side of the square cross section and a receiver gas port 416 diametrically opposed on the opposite side of the square cross section. Other cross sectional shapes, such as ovals, rectangles, teardrops, diamonds, triangles, and the like may also be used to ensure a proper alignment of the cartridge 402 within the cartridge receiver 406. In one embodiment, the cartridge interface 404 has a different cross sectional shape than the cartridge 402, and the shape of the cartridge interface 404 ensures that the cartridge 402 has a proper insertion path and alignment within the cartridge receiver 406. The cartridge receiver 406 may have a shape corresponding to the cross sectional shape of the cartridge interface 404.

Preferably, the biasing force created by the biasing member 414 is such that a friction fit is created between the cartridge receiver 406 and the cartridge interface 404. In one embodiment, this friction fit is strong enough to retain the cartridge 402 in cartridge receiver 406 when the cartridge receiver 406 is jarred, bumped, or turned upside down. In certain embodiments the facing walls 418a, 418b include additional biasing members or catches such as one or more nubs 420 and corresponding recesses 422 on opposites sides of the facing walls 418a, 418b.

In certain embodiments, the biasing member 414 may comprise another port in the cartridge receiver 406 and/or in the cartridge interface 404. For example, the biasing member 414 may comprise a receiver port such as a receiver fluid outlet port that allows a fluid such as water or hydrogen to flow into an interface fluid inlet port. The port may include a compliant element that compresses upon insertion of the cartridge 402, for example, a rubber or elastomeric O ring. The compressed compliant element may generate the biasing force that holds the interface gas outlet port 408 to the receiver gas inlet port 416.

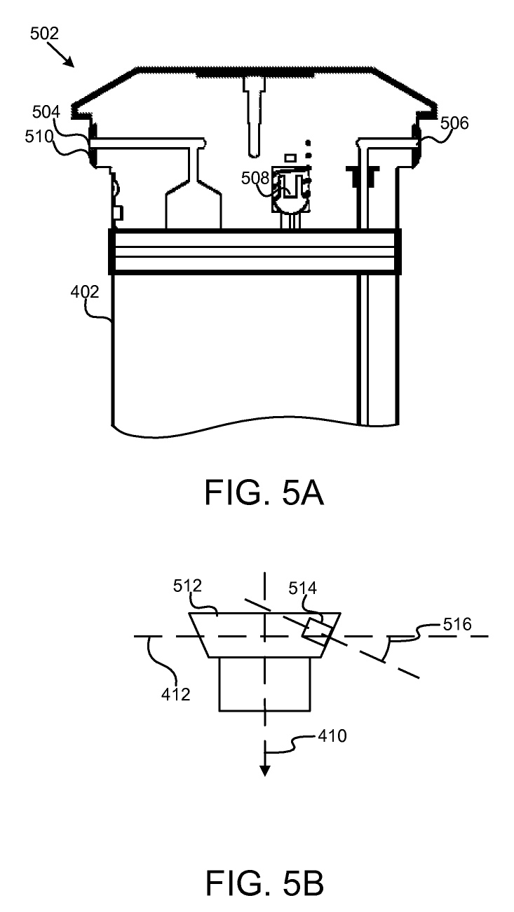

The biasing member 414, in one embodiment, may be prefabricated, injection molded, over-molded, or otherwise manufactured. In another embodiment, the biasing member 414 may be integrated with one or more of the cartridge receiver 406 and the cartridge interface 404 at manufacture time. An embodiment of the present invention that includes a receiver port that allows a fluid such as water or hydrogen to flow into an interface fluid inlet port is described in relation to FIG. 5A.

The receiver gas port 416, in one embodiment, receives the flow of hydrogen gas from the interface gas outlet port 408. Alternatively, the receiver gas port 416 may comprise a receiver fluid inlet port that receives a flow of another fluid from the interface gas outlet port 408. The receiver gas port 416 is configured to couple with the interface gas outlet port 408. In one embodiment, the receiver gas port 416 is coupled to the interface gas outlet port 408 under a force generated by a biasing member 414, as described above.

In one embodiment, the receiver gas port 416 is oriented in an orientation angle 413 relative to a plane orthogonal to the insertion path 410 of the cartridge 402. In certain embodiments, the orientation angle 413 of the receiver gas port 416 is such that the receiver gas port 416 aligns with the interface gas outlet port 408. In certain embodiments, the orientation angle 413 of the receiver gas port 416 is substantially the same as the orientation angle 411 of the interface gas outlet port 408. In the embodiment illustrated in FIG. 4, the receiver gas port 416 and the interface gas outlet port 408 have an orientation angle 411, 413 of between about zero and about five degrees. In another embodiment, the receiver gas port 416 may have an orientation angle 413 from zero to 90 degrees in any direction from the orthogonal plane 412. In another embodiment, the receiver gas port 416 may have any orientation angle 413 from zero to 45 degrees in any direction from the orthogonal plane 412.

In certain embodiments, the interface gas outlet port 408 sweeps across the receiver gas port 416 as the cartridge 402 is inserted along the insertion path 410 into the cartridge receiver 406. In other words, the interface gas outlet port 408 and the receiver gas port 416 are configured to interfere with each other and slide against each other as the cartridge 402 is inserted into the cartridge receiver 406. As the interface gas outlet port 408 sweeps across the receiver gas port 416, contaminants disposed on the interface gas outlet port 408 and/or the receiver gas port 416 are dislodged from the interface gas outlet port 408 and/or the receiver gas port 416, providing a self-cleaning interface between interface gas outlet port 408 and the receiver gas port 416.

For example, the interface gas outlet port 408 and the receiver gas port 416 may have orientation angles of about three degrees. In this example, the interface gas outlet port 408 and/or the receiver gas port 416 may sweep across one another as the cartridge 402 is inserted into the cartridge receiver 406. Contaminants such as dirt particles disposed on the interface gas outlet port 408 and/or the receiver gas port 416 that protrude beyond the interface gas outlet port 408 and/or the receiver gas port 416 will be perturbed by the sweeping action, and will be dislodged.

FIG. 4B illustrates a side view of an alternate embodiment of a hydrogen generation system interface 423 according to the present invention. The hydrogen generation system interface 423 includes a cartridge 402, a cartridge interface 404, and a cartridge receiver 406. The hydrogen generation system interface 400 provides a fluid pathway for a flow of hydrogen generated by a hydrogen generation system. The cartridge 402, cartridge interface 404, and cartridge receiver 406 are preferably configured in a like manner to similarly numbered components described in relation to FIG. 4A.

The cartridge interface 404, in one embodiment, includes a shoulder 424. The shoulder 424 may be configured to align the cartridge 402 relative to the cartridge receiver 406. In one embodiment, the shoulder 406 interfaces with the cartridge receiver 406 when the cartridge 402 is inserted to the proper depth.

In one embodiment, the cartridge receiver 406 comprises a support surface 426 through which the cartridge 402 is inserted. The support surface 426 may interact with the shoulder 424 to align the cartridge interface 404 in the cartridge receiver 406.

Beneficially, a cartridge receiver 406 comprising a support surface 426 through which the cartridge 402 is inserted allows the use of differing lengths of cartridge 402 in the same cartridge receiver 406. Since the shoulder 424 aligns the cartridge interface 404 in the cartridge receiver 406 independent of the length of the cartridge 402, cartridges of varying lengths may be employed.

FIG. 5A illustrates a side view of one embodiment of a cartridge interface 502. The cartridge interface 502 may include an interface gas outlet port 504, an interface fluid inlet port 506, and a pressure relief valve 508. In one embodiment, the cartridge interface 502 is coupled to a cartridge 402 similar to the like numbered cartridge 402 described in relation to FIG. 4. The cartridge interface 502 provides a pathway for the flow of fluids and couples the cartridge 402 to other elements of a hydrogen generation system.

The interface gas outlet port 504, in one embodiment, is configured in a similar manner to the interface gas outlet port 408 described in regard to FIG. 4. The interface gas outlet port 504 may include an orientation angle and provide a pathway for a flow of hydrogen gas or another fluid from the interior of the cartridge 402. In one embodiment, the interface gas outlet port 504 includes a seal 510. The seal 510, in one embodiment, substantially circumscribes the gas outlet port 504. The seal 510 may comprise a compliant material that seals the interface gas outlet port 504 to a corresponding receiver gas port 416 in a cartridge receiver 406. The seal 510 may comprise any material capable of sealing a flow of hydrogen gas, such as nylon, synthetic rubber, or the like. In one embodiment, the seal 510 comprises a synthetic rubber or elastomeric O ring. The seal 510, in one embodiment, comprises a biasing member, as previously described.

In one embodiment, each of the interface gas outlet port 504 and the interface fluid inlet port 506 normally operate under pressures of about 25-35 psig. In one embodiment, the interface gas outlet port 504 and/or the interface fluid inlet port 506 are configured to withstand high pressures without the seal 510 failing, because of the force of the biasing member, and the relatively small circumference of the interface gas outlet port 504 and/or the interface fluid inlet port 506.

The interface fluid inlet port 506, in one embodiment, provides a pathway for a flow of a fluid such as water into the interior of the cartridge 402. In one embodiment, the interface fluid inlet port 506 comprises a machined passageway into the cartridge interface 502. The interface fluid inlet port 506 may act as a biasing member 414 as described in relation to FIG. 4 in relation to the interface gas outlet port 504 and receiver gas port 416. Similarly, the interface gas outlet port 504 and receiver gas port 416 may cooperate to serve as a biasing member 414 for the interface fluid inlet port 506 and a receiver fluid port (not shown). The interface fluid inlet port 506, in one embodiment, is diametrically opposed to the interface gas outlet port 504. In an alternate embodiment, the interface fluid inlet port 506 may be adjacent to the interface gas outlet port 504.

In one embodiment, the interface fluid inlet port 506 comprises an orientation angle. The orientation angle of the interface fluid inlet port 506, in one embodiment, may be substantially similar to the orientation angle of the interface gas outlet port 504 described above. In another embodiment, the interface fluid inlet port 506 and the interface gas outlet port 504 may have orientation angles having similar magnitudes but in opposite directions, for example, one port having an orientation directed toward one side of the orthogonal plane and the other port having an orientation angle directed toward an opposite side of the orthogonal plane. In a further embodiment, the interface fluid inlet port 506 and the interface gas outlet port 504 may have different orientation angles.

The pressure relief valve 508 acts to limit the maximum pressure generated within the cartridge 402. In one embodiment, the pressure relief valve 508 comprises a pressure relief valve as known in the art, such as a spring driven valve that opens at a pre-determined threshold gas pressure. In one embodiment, the pressure relief valve 508 vents excess hydrogen gas to the atmosphere when the pressure relief valve 508 activates. In an alternate embodiment, the pressure relief valve 508 is connected to a containment volume (not shown) that contains the excess hydrogen gas. The containment volume may gradually or otherwise safely release the excess hydrogen gas.

FIG. 5B illustrates a side view of one embodiment of a cartridge interface 512. The cartridge interface 512 may include an interface port 514. The interface port 514 may comprise an interface fluid outlet port, an interface fluid inlet port, and may be substantially similar to the interface gas outlet port 504 and/or the interface fluid inlet port 506 of FIG. 5A described above. In one embodiment, the interface port 514 has an orientation angle 516 relative to an orthogonal plane 412, the orthogonal plane 412 orthogonal to an insertion path 410.

As described above, the orientation angle 516 may be any angle from zero to 90 degrees. In certain embodiments, the orientation angle 516 may aid in the cleaning of the interface port 514 upon insertion. In another embodiment, the orientation angle 516 may direct the interface gas port 514 downward such that a gravitational force aides in sealing the interface port 514 upon insertion.

For example, in the illustrated embodiment, the orientation angle 516 of the interface port 514 is about thirty degrees. In this example, there will be some sweeping action upon insertion. A component of the gravitational force will also contribute to sealing the interface port 514. Also, a biasing member will generate a force, with a component of the force from the biasing member acting to seal the interface port 514. The biasing member may comprise another interface port that diametrically opposes the interface port 514, and may also comprise an orientation angle 516. In certain embodiments, the orientation angle 516 is less than 90 degrees, such that the interface port 514 and the insertion path 410 are nonparallel. In embodiments where the interface port 514 and the insertion path 410 are nonparallel, the force generated by the biasing member will not be directed solely along the insertion path, minimizing forces that may unseat the cartridge interface 512 from a cartridge receiver, that may force the cartridge receiver apart, and that may prevent the interface 514 from sealing.

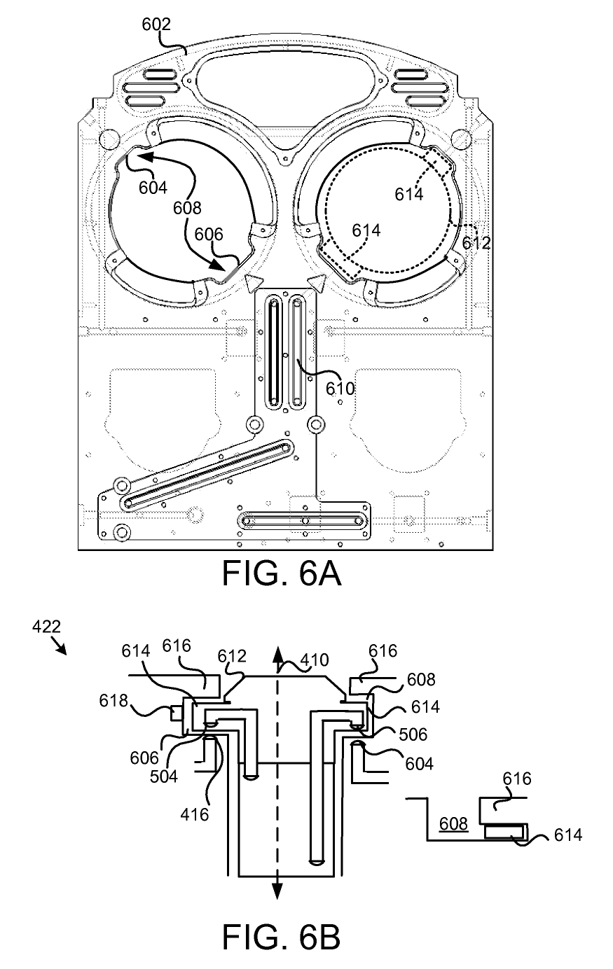

FIG. 6A illustrates one embodiment of a top view of a cartridge receiver 602 according to the present invention. The cartridge receiver 602, in one embodiment, includes a receiver fluid port 604, a receiver gas port 606, one or more keyways 608, and one or more passages 610. The cartridge receiver 602 receives a cartridge 402 and provides a pathway for the passage of a fluid such as hydrogen gas.

The receiver fluid port 604 comprises a passageway in the cartridge receiver 602 configured to allow a flow of a fluid such as water to enter a cartridge interface fluid port 506. The receiver fluid port 604 may be disposed on the cartridge receiver 602 such that the receiver fluid port 604 mates with the cartridge interface fluid port 506 upon insertion of a cartridge into the cartridge receiver 602.

The receiver gas port 606 comprises a passageway into the cartridge receiver 602 configured to allow a flow of hydrogen gas to pass from an interface gas outlet port 504. The receiver gas port 606 may be disposed on the cartridge receiver 602 such that the receiver gas port 606 mates with the interface gas outlet port 504 upon insertion of a cartridge 612 into the cartridge receiver 602.

In one embodiment, the receiver gas port 606 and the receiver fluid port 604 are diametrically opposed, as shown in FIG. 6A. In an alternate embodiment, the receiver gas port 606 and the receiver fluid port 604 are not diametrically opposed. In certain embodiments, the receiver fluid port 604 acts as a biasing member generating a force to seal the receiver gas port 606 and the receiver fluid port 604 simultaneously.

The cartridge receiver 602, in one embodiment, includes one or more alignment features such as one or more keyways 608. The one or more keyways 608 correspond to one or more like-shaped keys 614 on the cartridge interface of the cartridge 612. The one or more keyways 608 and keys 614 ensure that the cartridge 612 is oriented in a particular direction upon insertion of the cartridge 612 into the cartridge receiver 602. In one embodiment, the one or more keyways 608 and keys 614 ensure that the receiver gas port 606 is aligned with a corresponding interface gas outlet port 504.

In the depicted embodiment, a user rotates the cartridge 612 about its longitudinal axis and/or its insertion path until the keyways 608 match up to corresponding keys 614. Once the keyways 608 match up with keys 614, the cartridge 612 seats within the cartridge receiver 602, and is properly aligned within the cartridge receiver 602. Those of skill in the art will recognize a variety of keyway 608 and keys 614 configurations that can be used between the cartridge 612 and the cartridge receiver 602. All of these configurations are considered within the scope of the present invention.

The one or more alignment features may be incorporated with the interface gas outlet port 514 in one embodiment. In another embodiment, the one or more alignment features may be incorporated with the interface fluid port 506. For example, the cartridge 612 may include an interface gas outlet port 514 incorporated into keys 614 on the cartridge 612.

In the embodiment of FIG. 6B, the keyways 608 have a substantially “L” shaped cross-section such that keys 614 are secured in the keyway 608 by one or more hold-downs 616. In one embodiment, the one or more hold-downs 616 may comprise biasing members that press the interface fluid ports 506, 604 against the receiver fluid ports 416, 604. The cartridge 612 is inserted along the insertion path 410 and the keys 614 enter the keyways 608. Next, the cartridge 612 is twisted about the insertion path 410 such that the keys 614 are engaged by the hold downs 616. Engagement by the one or more hold downs 616 ensures the gas ports 504,606 and fluid ports 506, 604 are aligned. For additional safety, a sensor 618 within the keyway 608 registers if the cartridge 612 is properly aligned.

Referring back to FIG. 6A, the one or more passages 610 provide a pathway for a flow of generated hydrogen gas. In one embodiment, the one or more passages 610 comprise channels machined into the cartridge receiver 602. In an alternate embodiment, the one or more passages 610 comprise channels formed into the cartridge receiver 602. In one embodiment, the one or more channels 610 include a cover plate (not shown) that forms a wall for one or more of the channels 610.

In certain embodiments, the one or more channels 610 form a manifold that connects two or more flows of hydrogen gas. For example, in one embodiment, the cartridge receiver 602 is configured to receive a plurality of cartridges. In the depicted embodiment, the cartridge receiver 602 is configured to receive two cartridges. In this example, the flow of hydrogen gas generated by each cartridge may be combined in the one or more passages 610 to form a single flow of hydrogen. In one embodiment, the cartridge receiver 602 is configured to receive a plurality of cartridges that may be independently inserted and removed, and may be independently operated. Alternatively, or in addition, the cartridge receiver 602 is configured to receive two or more cartridges. Furthermore, the cartridges 602 may contain a fluid processing component such as a fluid filtration component, a fluid generation component, a fluid consumption component, or a fluid containment component.

To facilitate independent operation of a plurality of cartridges, in one embodiment, the one or more passages 610 may comprise one or more check valves or other valve types, as described above with regard to the check valve 130 of FIG. 1. Valves in the cartridge receiver 602 allow hydrogen or another fluid to flow from a first cartridge into the receiver 602 regardless of the state of a second cartridge. This allows for hot-pluggable cartridges that can be inserted and removed during operation of a system. In a further embodiment, one or more of the interface fluid ports 504, 506 may be configured to open valves or passages in the receiver fluid ports 416, 604 when inserted into the cartridge receiver 602, the valves or passages closing when the cartridge is removed from the cartridge receiver 602.

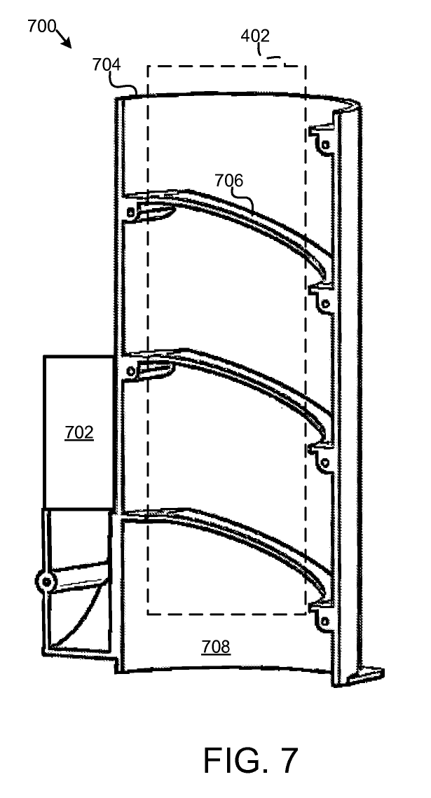

FIG. 7 illustrates a cross-section side view of one embodiment of a cooling module 700 according to the present invention. The cooling module 700, in one embodiment, is substantially similar to the cooling module 112 of FIG. 1, described above. The cooling module 700 may comprise a fluid moving module 702, a shroud 704, and one or more ribs 706. The cooling module 700 cools a cartridge 402 in a hydrogen generation system, conducting heat away from the cartridge 402.

The fluid moving module 702, in one embodiment, may comprise a pump, a blower, a fan, or another fluid mover that causes a fluid such as air or water to travel through other components of the cooling module 700. The fluid absorbs heat from the cartridge 402 through conduction and carries the heat out of the hydrogen generation system. In one embodiment, the fluid may comprise a gas such as air, or a liquid coolant such as water. The fluid may comprise other liquid or solid coolants that may be additives to a liquid such as water, an alcohol, or the like. The fluid may also comprise one or more antifreeze materials for use in extreme temperatures.

In one embodiment, the shroud 704 is disposed within or below the cartridge receiver 602 and substantially surrounds the cartridge 402 upon insertion. The shroud 704 may be made from any material that directs a flow of air, but is preferably made from a light, rigid material, such as a plastic. In one embodiment, the fluid moving module 702 comprises an air moving module, and the shroud 704 comprises an air guide containing air blown by the fluid moving module 702 as the air passes across the surface of the cartridge 402.

In another embodiment, the fluid moving module 702 comprises a pump, and the shroud 704 comprises a fluid guide that is disposed adjacent to the cartridge 402 upon insertion of the cartridge 402. The shroud 704 may comprise a barrier between the cartridge 402 and the liquid, conducting heat from the cartridge 402 to the liquid. In a further embodiment, the shroud 704 comprises a liquid jacket such as a water jacket that substantially circumscribes the cartridge 402 upon insertion, and the fluid moving module 702 moves a liquid through the liquid jacket.

In one embodiment, the fluid moving module 702 moves a liquid such as air or water into the shroud 702 near a bottom 708 of the shroud 702. In the depicted embodiment, a fluid flows from the bottom of the cartridge 402 to the top of the cartridge 402 as the liquid absorbs heat. The bottom 708 of the shroud 702 may comprise a fluid intake port, or an air intake port that is in fluid communication with the fluid moving module 702. The shroud 702 may also comprise a fluid outlet port, or an air exhaust port, that is positioned near a top of the cartridge receiver 602. The fluid outlet port or air exhaust port, in one embodiment, may be integrated with the cartridge receiver 602.

In one embodiment, the one or more ribs 706 channel the flow of fluid. In certain embodiments, the one or more ribs 706 comprise a single helical rib that causes the flow of fluid, such as an airflow, from the fluid moving module 702 to travel in a helical path around the cartridge. Beneficially, such a helical path increases a residence time that the fluid is in contact with the surface of the cartridge. The vertical spacing between the ribs 706 is directly proportional to the dwell time. The closer the ribs 706 are spaced vertically the tighter the helical curves and the higher the dwell time, so long as the speed of the fluid moving module 702 is reduced to compensate for increased fluid speed due to a smaller helical fluid channel around the cartridge 402. Alternatively, the ribs 706 may have other configurations which increase the dwell time of the cooling fluid.

The ribs 706, in one embodiment, induce turbulence in the flow of fluid, such as air or water, from the fluid moving module 702. The ribs 706 may induce turbulence through any method known in the art, such as by being formed at an angle to a flow of fluid, by including ridges or undulations, by adding protrusions separate from the ribs 706, or in a like manner. Turbulence induced in the flow of fluid from the fluid moving module 702 improves the transfer of heat from the cartridge 402 to the flow of fluid.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to secure a cartridge, the apparatus comprising:
a cartridge comprising a cartridge interface;
an interface fluid outlet port disposed on the cartridge interface, the interface fluid outlet port in fluid communication with an interior of the cartridge, the interface fluid outlet port configured to mate with a receiver fluid inlet port of a cartridge receiver;
an orientation angle measured between the interface fluid outlet port and a plane orthogonal to an insertion path of the cartridge such that the interface fluid outlet port and the insertion path of the cartridge are nonparallel; and
a biasing member configured to apply a biasing force that presses the interface fluid outlet port against the receiver fluid inlet port.

2. The apparatus of claim 1, further comprising an interface fluid inlet port disposed on the cartridge interface, the interface fluid inlet port in fluid communication with the interior of the cartridge, the interface fluid inlet port configured to mate with a receiver fluid outlet port of the cartridge receiver.

3. The apparatus of claim 2, wherein the interface fluid inlet port has an orientation angle, the orientation angle measured from a plane orthogonal to the insertion path of the cartridge such that the fluid inlet port and the insertion path of the cartridge are nonparallel, the interface fluid inlet port diametrically opposed to the interface fluid outlet port such that the biasing force further presses the interface fluid inlet port against the receiver fluid outlet port.

4. The apparatus of claim 1, further comprising one or more alignment features configured to ensure that the insertion path of the cartridge and an alignment of the cartridge are proper.

5. The apparatus of claim 4, wherein the interface fluid outlet port is incorporated into the one or more alignment features.

6. The apparatus of claim 4, wherein the one or more alignment features comprise one or more shoulders configured to interface with a support surface of the cartridge receiver.

7. The apparatus of claim 4, wherein the one or more alignment features comprise a shape of the cartridge and a corresponding shape of the cartridge interface.

8. The apparatus of claim 4, wherein the one or more alignment features allow the cartridge to rotate at least partially about the insertion path to achieve a proper alignment.

9. The apparatus of claim 1, wherein the cartridge is configured to contain a hydrogen generating reaction comprising a chemical reaction between a liquid and a solid hydride reactant.

10. The apparatus of claim 9, further comprising a liquid permeable material disposed within the cartridge, the liquid permeable material comprising one or more cavities, each cavity configured to contain the solid hydride reactant, the solid hydride reactant comprising a solid anhydrous chemical hydride.

11. The apparatus of claim 1, wherein the cartridge is configured to contain a fluid processing component selected from the group consisting of a fluid filtration component, a fluid generation component, a fluid consumption component, and a fluid containment component.

12. The apparatus of claim 1, wherein the biasing member is at least partially elastomeric and is configured to compress to generate the biasing force in response to an insertion of the cartridge into the cartridge receiver.

13. The apparatus of claim 12, wherein the biasing member comprises a seal substantially circumscribing the interface fluid outlet port.

14. An apparatus to secure a cartridge, the apparatus comprising:
a cartridge receiver configured to receive a cartridge interface of a cartridge;
a receiver gas port disposed on the cartridge receiver, the receiver gas port configured to mate with an interface gas outlet port of the cartridge interface;
a biasing member configured to apply a biasing force that presses the receiver gas port against the interface gas outlet port, the biasing member removably securing the cartridge to the cartridge receiver;
a cartridge cooling module configured to conduct heat away from the cartridge.

15. The apparatus of claim 14, further comprising a receiver fluid port disposed on the cartridge receiver, the receiver fluid port configured to mate with an interface fluid inlet port of the cartridge interface, the receiver fluid port and the receiver gas port disposed opposite each other and configured to apply the biasing force to the interface gas outlet port and to the interface fluid inlet port.

16. The apparatus of claim 14, wherein the cartridge receiver is configured to receive a plurality of cartridges, each cartridge comprising a cartridge interface, the cartridge receiver further configured to allow independent operation of each of the plurality of cartridges.

17. The apparatus of claim 14, wherein the biasing member is further configured to remove contaminants from the interface gas outlet port in response to an insertion of the cartridge into the cartridge receiver.

18. The apparatus of claim 14, wherein the cartridge cooling module comprises a fluid moving module configured to cause a fluid to move through a fluid guide disposed adjacent to the cartridge in the cartridge receiver.

19. The apparatus of claim 18, wherein the fluid comprises air, and the fluid guide comprises a helical rib formed in the cartridge receiver, the helical rib forming a helical path for airflow around the cartridge when the cartridge is positioned within the cartridge receiver.

20. The apparatus of claim 18, wherein the fluid guide is further configured to create turbulence in the fluid from the fluid moving module.

21. The apparatus of claim 18, wherein the fluid guide comprises a water jacket.

22. A system to secure a fuel cartridge that generates hydrogen, the system comprising:
a fuel cartridge configured to contain a hydrogen generating reaction, the fuel cartridge comprising a cartridge interface;
an interface gas outlet port disposed on the cartridge interface, the interface gas outlet port in fluid communication with the interior of the fuel cartridge;
a cartridge receiver configured to receive the cartridge interface of the fuel cartridge;
a receiver gas port disposed on the cartridge receiver, the receiver gas port configured to mate with the interface gas outlet port; and
a biasing member configured to apply a biasing force that presses the interface gas outlet port against the receiver gas port, the biasing member removably securing the fuel cartridge to the cartridge receiver.

23. The system of claim 22, further comprising a pressure relief valve configured to release hydrogen gas in response to an internal gas pressure above a threshold gas pressure.

24. The system of claim 22, further comprising a full insertion module configured to prevent an operation of the system in response to an improper insertion of the fuel cartridge.

25. The system of claim 24, wherein the full insertion module comprises a cover, the fuel cartridge preventing the cover from fully closing when the fuel cartridge is improperly inserted in the cartridge receiver.
